(19) United States
(12) Patent Application Publication
(10) Pub. No.: US 2025/0338363 A1
(43) Pub. Date: Oct. 30, 2025

(54) APPARATUS FOR HEATING NON-COATED PORTION OF FOIL

(71) Applicant: SK On Co., Ltd., Seoul (KR)

(72) Inventors: You Seok KIM, Daejeon (KR); Min Ki LEE, Daejeon (KR)

(21) Appl. No.: 19/192,344

(22) Filed: Apr. 29, 2025

(30) Foreign Application Priority Data
Apr. 30, 2024 (KR) 10-2024-0057289

(51) Int. Cl. H05B 6/10; G01J 5/02; H01M 4/04; H05B 6/06

(52) U.S. Cl. CPC H05B 6/101; G01J 5/0205; H01M 4/0471; H05B 6/06; H05B 2213/07

(57) ABSTRACT

An apparatus for heating a non-coated portion of foil includes a temperature detection unit spaced apart from one side of a non-coated portion of foil of an electrode sheet, configured to detect a temperature of the non-coated portion of foil in a non-contact manner and configured to output a temperature detection signal; a controller configured to control heating of the non-coated portion of foil based on a temperature detection signal from the temperature detection unit; and a heating means spaced apart from the other side of the non-coated portion of foil of the electrode sheet, and configured to heat the non-coated portion of foil under control of the controller.

### CROSS-REFERENCE TO RELATED APPLICATION(S)

This application claims benefit of priority to Korean Patent Application No. 10-2024-0057289 filed on Apr. 30, 2024 in the Korean Intellectual Property Office, the disclosure of which is incorporated herein by reference in its entirety.

### TECHNICAL FIELD

The present disclosure generally relates to an apparatus for heating a non-coated portion of foil.

### BACKGROUND

Generally, a process of manufacturing a battery may include an electrode coating process and an electrode rolling process. The electrode coating process may be a process of producing an electrode sheet including a coated portion and a non-coated portion by coating a portion of metal foil with an electrode material (electrode active material). The electrode rolling process may be a process of rolling the electrode sheet to appropriately reduce a thickness of the electrode sheet including a coated portion and a non-coated portion.

Generally, in an electrode rolling process, when rolling an electrode sheet, fractures such as thermal wrinkles, cracks, or tears may occur in the electrode sheet due to a difference in an elongation rate between a coated portion and a non-coated portion of the electrode sheet. In order to prevent this disadvantage, a process of heating the non-coated portion of the electrode sheet may be necessary before the electrode rolling process.

The method of heating a non-coated portion may be adopted as a method of controlling a heating temperature based only on a speed of a rolling roll of the electrode rolling process. However, when the heating method is adopted, a difference in elongation rates of foil types, which may be different from each other, may not be reflected, and an appropriate heating temperature may not be formed for each foil type, such that fractures may occur in the electrode sheet.

### SUMMARY

An embodiment of the present disclosure is to provide an apparatus for heating a non-coated portion of foil which may control a heating temperature of a non-coated portion differently depending on types of an electrode foil in order to address the issue of fracture of an electrode sheet occurring in an electrode rolling process.

A battery which may use an apparatus for heating a non-coated portion of foil in an electrode rolling process may be widely applied in green technology fields such as an electric vehicle, a battery charging station, and a solar power generation and wind power generation using batteries. Also, the battery which may use an apparatus for heating a non-coated portion of foil in an electrode rolling process may be used in an eco-friendly electric vehicle, a hybrid vehicle, or the like, to ameliorate the effects of climate change by suppressing air pollution and greenhouse gas emissions.

According to an aspect of the present disclosure, an apparatus for heating a non-coated portion of foil includes a temperature detection unit spaced apart from one side of a non-coated portion of foil of an electrode sheet, configured to detect a temperature of the non-coated portion of foil in a non-contact manner and configured to output a temperature detection signal; a controller configured to control heating of the non-coated portion of foil based on a temperature detection signal from the temperature detection unit; and a heating means spaced apart from the other side of the non-coated portion of foil of the electrode sheet, and configured to heat the non-coated portion of foil under control of the controller.

The temperature detection unit includes an infrared temperature sensor spaced apart from one side of the non-coated portion of foil to detect a temperature of the non-coated portion of foil.

The heating means includes an electromagnetic induction heating coil spaced apart from the other side of the non-coated portion of foil so as to heat the non-coated portion of foil under control of the controller.

The heating means includes a first support spaced apart from the other side of the non-coated portion of foil so as to be spaced apart from a lower surface of the non-coated portion of foil; a heating plate disposed on an upper surface of the first support; and an electromagnetic induction heating coil disposed on the heating plate and spaced apart from the other side of the non-coated portion of foil so as to heat the non-coated portion of foil under control of the controller.

The temperature detection unit includes an infrared temperature sensor spaced apart from one side of the non-coated portion of foil to detect a temperature of the non-coated portion of foil; and a second support configured to support and hold the infrared temperature sensor so as to be spaced apart from one side of the non-coated portion of foil.

The controller further includes a comparator configured to compare the temperature detection signal with a predetermined target temperature; and a driving signal generator configured to generate a driving signal controlled according to a comparison result of the comparator.

The comparator includes a first comparator configured to output a first comparison signal by comparing the temperature detection signal with an upper limit of the target temperature; and a second comparator configured to output a second comparison signal by comparing the temperature detection signal with a lower limit of the target temperature.

An upper limit of the target temperature is determined to be higher than an intermediate value of the target temperature by a predetermined error tolerance value, and wherein a lower limit of the target temperature is determined to be lower than an intermediate value of the target temperature by a predetermined error tolerance value.

The driving signal generator includes a driving current generator configured to control a current value of the driving signal according to the first comparison signal and the second comparison signal.

### BRIEF DESCRIPTION OF DRAWINGS

Predetermined aspects, features, and advantages of the present disclosure are illustrated by the following detailed description with reference to the accompanying drawings.

FIG. 1 is a diagram illustrating an apparatus for heating a non-coated portion of foil according to an embodiment of present disclosure;

FIG. 2 is a diagram illustrating an apparatus for heating a non-coated portion of foil according to an embodiment of present disclosure;

FIG. 3 is a diagram illustrating a temperature detection unit according to an embodiment of present disclosure;

FIG. 4 is a diagram illustrating a heating means according to an embodiment of present disclosure;

FIG. 5 is a diagram illustrating operations of a heating means according to an embodiment of present disclosure;

FIG. 6 is a diagram illustrating an implementation structure of a heating means according to an embodiment of present disclosure;

FIG. 7 is a diagram illustrating an implementation structure of a temperature detection unit according to an embodiment of present disclosure;

FIG. 8 is a diagram illustrating a controller according to an embodiment of present disclosure;

FIG. 9 is a diagram illustrating a comparator according to an embodiment of present disclosure;

FIG. 10 is a diagram illustrating an upper limit of target temperature and a lower limit of target temperature according to an embodiment of present disclosure; and

FIG. 11 is a diagram illustrating a driving signal generator according to an embodiment of present disclosure.

### DETAILED DESCRIPTION

The embodiments of the present disclosure are illustrated in embodiments with reference to the accompanying drawings.

In the drawings, same elements will be indicated by same reference numerals. Also, redundant descriptions and detailed descriptions of known functions and elements which may unnecessarily make the gist of the present disclosure obscure will not be provided. Even when the drawings illustrate components having the same reference number, the plurality of drawings do not refer to the same embodiment.

In embodiments, the terms, “include,” “comprise,” “is configured to,” or the like of the description are used to indicate the presence of features, numbers, steps, operations, elements, portions or combination thereof, and do not exclude the possibilities of combination or addition of one or more features, numbers, steps, operations, elements, portions or combination thereof.

The terms “first,” “second,” and the like may be used to distinguish one element from the other, and may not limit a sequence and/or an importance, or others, in relation to the elements. In some cases, a first element may be referred to as a second element, and similarly, a second element may be referred to as a first element without departing from the scope of right of the embodiments.

An expression used in the singular encompasses the expression of the plural, unless it has a clearly different meaning in the context. It should be understood that terms such as “include” or “have” are intended to specify the presence of a feature, number, step, operation, component, part, or combination thereof described in the specification, but do not exclude in advance the possibility of the presence or addition of one or more other features, numbers, steps, operations, components, parts, or combinations thereof.

Unless otherwise indicated, all terms used herein, including technical or scientific terms, have the same meaning as commonly understood by one of ordinary skill in the art to which the present disclosure belongs. Terms defined in commonly used dictionaries should be interpreted to be consistent with the context of the relevant art, and will not be interpreted in an idealized or overly formal sense unless expressly defined in this application.

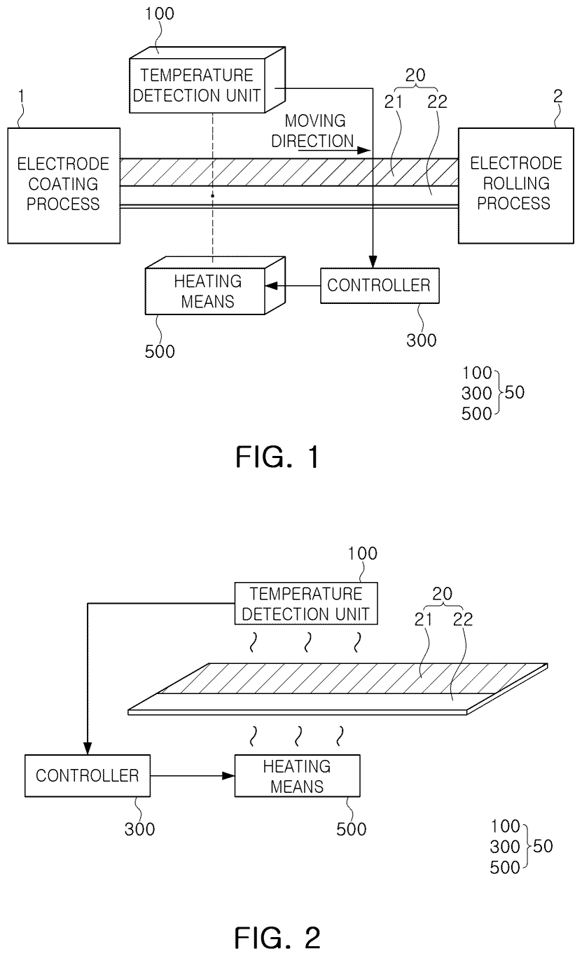

FIG. 1 is a diagram illustrating an apparatus for heating a non-coated portion of foil according to an embodiment.

Referring to FIG. 1, an apparatus for heating a non-coated portion of foil 50 according to an embodiment may include a temperature detection unit 100, a controller 300, and a heating means 500.

The temperature detection unit 100 may be spaced apart from one side (e.g., upper side) of the non-coated portion 22 of foil included in the electrode sheet 20 to detect a temperature of the non-coated portion 22 of foil of the electrode sheet 20 output by the electrode coating process 1 and transferred to the electrode rolling process 2. For example, the electrode sheet 20 may include a foil coating portion 21 coated with an electrode material (electrode active material) on a portion of metal foil and a non-coated portion 22 of foil, not coated.

The heating means 500 may be spaced apart from the other side (e.g., lower side) of the non-coated portion 22 of the electrode sheet 20 to heat the non-coated portion 22.

The controller 300 may be electrically connected to the temperature detection unit 100 and the heating means 500, and may control the heating means 500 to heat the non-coated portion 22 of foil to an appropriate temperature based on the temperature of the non-coated portion 22 of foil detected by the temperature detection unit 100.

In FIG. 1, the dotted line between the temperature detection unit 100 and the heating means 500 may indicate a vertical upper portion and a vertical lower portion centered on the non-coated portion 22.

For example, tensile strength of a general electrode foil may be 1800 (kgf/cm²) or more, and in the case of a high-strength electrode foil, tensile strength may be 2500 to 2700 (kgf/cm²). When the electrode foil is a high-strength foil, deformation may occur at a boundary due to a difference in elongation of the foil coating portion 21 and the non-coated portion 22 of foil during rolling (pressing). By applying the apparatus for heating a non-coated portion of foil in embodiments, the issues such as an increase in the frequency of deformation and fracture in the high-strength electrode foil, an increase in thickness and tensile strength, and high rolling pressure.

FIG. 2 is a diagram illustrating an apparatus for heating a non-coated portion of foil according to an embodiment.

Referring to FIG. 2, an apparatus for heating a non-coated portion of foil 50 according to an embodiment may include a temperature detection unit 100, a controller 300, and a heating means 500 as illustrated in FIG. 1.

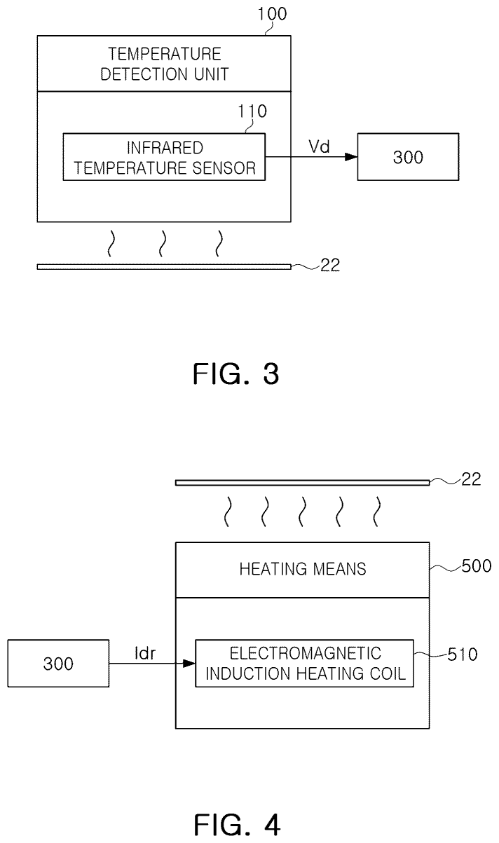

The temperature detection unit 100 may detect a temperature of the non-coated portion 22 of foil of the electrode sheet 20 in a non-contact manner at one side (e.g., upper side) of the non-coated portion 22 of foil included in the electrode sheet 20, and may output a temperature detection signal Vd to the controller 300. For example, the temperature detection unit 100 may include at least one temperature sensor, which will be further described with reference to FIG. 3.

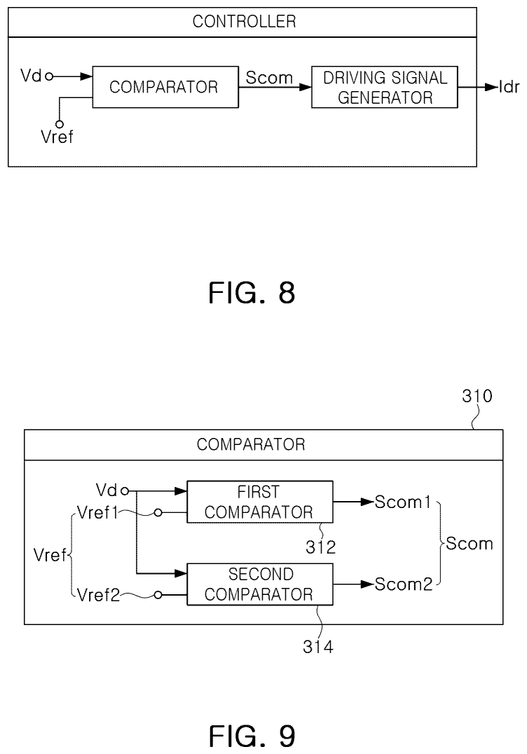

The controller 300 may control heating of the non-coated portion 22 based on the temperature detection signal Vd from the temperature detection unit 100. For example, the controller 300 may control the heating means 500 for heating the non-coated portion 22 based on the temperature detection signal Vd, which will be further described with reference to FIGS. 8 to 11.

The heating means 500 may heat the non-coated portion 22 under control of the controller 300. As an example, the heating means 500 may include at least one coil for heating by electromagnetic induction, which will be further described with reference to FIG. 4.

The battery cell to which the apparatus for heating a non-coated portion of foil in embodiments may be applied to a pouch cell, a cylindrical cell, a square cell, or the like, and is not limited to any specific structure or type.

In embodiments, the controller 300 may be implemented as hardware or software in at least one integrated circuit (IC) embedded in the apparatus for heating a non-coated portion of foil 50, but is not limited thereto. Also, the controller 300 may be implemented as at least one processor.

As for the drawings, unnecessary overlapping descriptions for components having the same symbol and the same function may not be provided, and possible differences may be described for each drawing.

FIG. 3 is a diagram illustrating a temperature detection unit according to an embodiment.

Referring to FIG. 3, for example, the temperature detection unit 100 may include a non-contact temperature sensor, and as an example, the temperature detection unit 100 may include an infrared temperature sensor 110, which is a non-contact temperature sensor, and in embodiments, the temperature detection unit 100 may be configured as a non-contact temperature sensor, but an embodiment thereof is not limited thereto.

The infrared temperature sensor 110 may be spaced apart from one side of the non-coated portion 22 of foil to detect the temperature of the non-coated portion 22 of foil, and may detect the temperature of the non-coated portion 22 of foil in a non-contact manner and may output a temperature detection signal Vd to the controller 300.

FIG. 4 is a diagram illustrating a heating means according to an embodiment.

Referring to FIG. 4, a heating means 500 may include an electromagnetic induction heating coil 510.

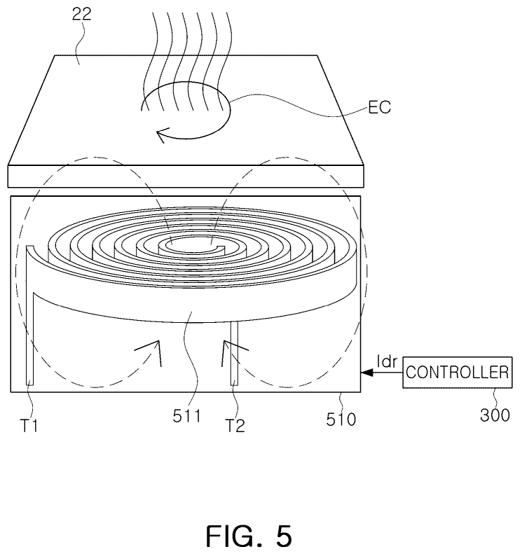

For example, the electromagnetic induction heating coil 510 may be spaced apart from the other side of the non-coated portion 22 of foil so as to heat the non-coated portion 22 of foil under control of the controller 300. For example, the electromagnetic induction heating coil 510 may form an electric field to generate heat according to a driving current, which is a driving signal input from the controller 300, which will be further described with reference to FIG. 5.

FIG. 5 is a diagram illustrating operations of a heating means according to an embodiment.

Referring to FIG. 5, an electromagnetic induction heating coil 510 may include a spiral coil 511 having a first end, which is an input/output terminal of the driving signal Idr, and a second terminal T2, which is connected to the controller 300.

For example, the spiral coil 511 may form an induced magnetic field having magnetic force lines around the coil by the driving current, which is the driving signal Idr, and the driving current may be a direct current or an alternating current. For example, when the driving current is a direct current, the electrode sheet 20 may be transported by the magnetic field of the spiral coil 511, and may have an upward and downward movement of the electrode sheet 20, and accordingly, an eddy current EC may flow on the surface of the non-coated portion 22 of foil formed of metal, such that the non-coated portion 22 of foil may be heated by resistance thereof.

For example, when the driving current is an alternating current, the electrode sheet 20 may be transferred by the magnetic field of the spiral coil 511, and the electrode sheet 20 may move up and down, and due to the driving current, which is an alternating current, the eddy current EC may flow on the surface of the non-coated portion 22 of foil formed of metal, and accordingly, the non-coated portion 22 of foil may be heated by resistance thereof.

For example, the eddy current EC may increase or decrease in proportion to the size of the driving current, and the heating temperature of the non-coated portion 22 of foil may increase or decrease according to the increase or decrease of the eddy current EC.

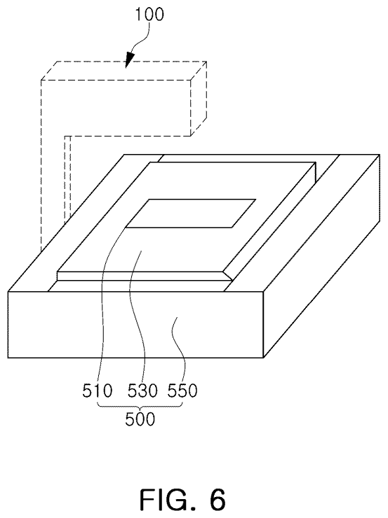

FIG. 6 is a diagram illustrating an implementation structure of a heating means according to an embodiment.

Referring to FIG. 6, a heating means 500 may include a first support 550, a heating plate 530, and an electromagnetic induction heating coil 510.

The first support 550 may be spaced apart from a lower surface of the non-coated portion 22 of foil on the other side (e.g., the lower portion) of the non-coated portion 22 of foil, and may support the heating plate 530 and the electromagnetic induction heating coil 510. For example, the first support 550 may support the electromagnetic induction heating coil 510 to be spaced apart from the lower surface of the non-coated portion 22 of foil by a predetermined distance in a state in which the non-coated portion 22 of foil is stopped on the other side of the non-coated portion 22 of foil.

The heating plate 530 may be disposed on the upper surface of the first support 550, and may perform a heating function together when the electromagnetic induction heating coil 510 is heated. For example, the size of the heating plate may be 13 cm*13 cm, and the size value is merely an example for ease of description and understanding, but an embodiment thereof is not limited thereto.

The electromagnetic induction heating coil 510 may be disposed on the heating plate 530 supported by the first support 550, and may be spaced apart from the lower side of the non-coated portion 22 of foil by a predetermined distance in a state in which the non-coated portion 22 of foil is stopped, and may be spaced apart from the other side of the non-coated portion 22 of foil so as to heat the non-coated portion 22 of foil under control of the controller 300.

For example, the predetermined distance may be determined in advance through an experiment such that the non-coated portion 22 of foil may be heated using the electromagnetic induction heating coil 510.

For example, when the width of the non-coated portion 22 is 2.5 cm, the heating means 500 may have a size in a width direction (e.g., 8 cm) which may cover the entire width of the non-coated portion 22, and a size in a length direction of 2 cm. For example, the size in the width direction (based on the electrode foil width direction) and the size in the length direction (based on the length direction of the electrode foil) of the electromagnetic induction heating coil 510 may be 8 cm*2 cm. That is, the length of the electromagnetic induction heating coil 510 may be 8 cm, and the width may be 2 cm.

The numerical examples for the size of the non-coated portion 22 and the heating means 500 are merely examples for ease of description and understanding, but an embodiment thereof is not limited thereto. For example, the heating temperature of the heating means 500 may be heated so as to be maintained in the range of 50° C. to 60° C., which is merely one example for ease of description and understanding, but an embodiment thereof is not limited thereto.

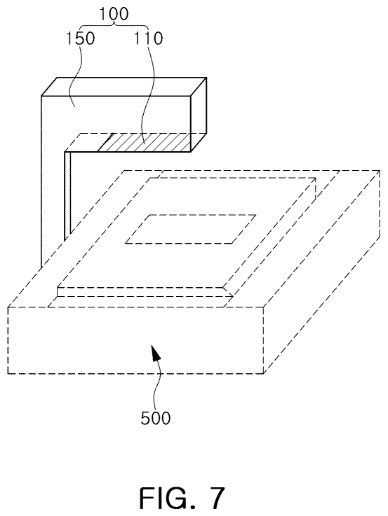

FIG. 7 is a diagram illustrating an implementation structure of a temperature detection unit according to an embodiment.

Referring to FIG. 7, a temperature detection unit 100 may include an infrared temperature sensor 110 and a second support 150.

The infrared temperature sensor 110 may be supported by the second support 150 and may be spaced apart from the upper side of the non-coated portion 22 of foil by a predetermined distance.

The second support 150 may support and hold the infrared temperature sensor 110 on one side of the non-coated portion 22 of foil, for example, the upper portion, so as to be spaced apart from the non-coated portion 22 of foil (e.g., the upper surface of the non-coated portion) by a predetermined distance.

For example, when the width of the non-coated portion 22 is 2.5 cm, the overall height of the second support 150 may be approximately 30 cm, the length of the second support 150 extended to the upper portion of the first support 550 may be approximately 10 cm, and the height distance from the first support 550 may be 10 cm. Also, the temperature detection unit 100 may have a size to overlap a portion in the width direction of the heating means 500 (the width direction of the electrode foil), and the length in the length direction of the electrode foil may be approximately 2 cm. The numerical examples for the distance and length are merely simple examples for ease of description and understanding, but an embodiment thereof is not limited thereto.

FIG. 8 is a diagram illustrating a controller according to an embodiment.

Referring to FIG. 9, a controller 300 may include a comparator 310 and a driving signal generator 330. For example, the controller 300 may be at least one processor, and each of the comparator 310 and the driving signal generator 330 may be a processor.

The comparator 310 may compare a temperature detection signal with a predetermined target temperature and may output a comparison signal Scom. For example, the target temperature Vref may be appropriately determined in advance according to the type of the electrode foil. For example, the temperature detection signal Vd of the comparator 310 may be a voltage value, the target temperature Vref may also be a voltage value, and the comparison signal Scom may be a logic signal including a value indicating logic ‘l’ or logic ‘0’ indicating whether the current temperature of the non-coated portion 22 of foil is high or low, but an embodiment thereof is not limited thereto.

For example, the target temperature Vref may be determined as a predetermined value according to the type of the electrode foil. Accordingly, using the apparatus for heating a non-coated portion of foil in embodiments, an appropriate heating temperature may be controlled according to the type of the electrode foil. For example, the type of the electrode foil may be a material of copper or aluminum, and the target temperature Vref may be predetermined differently depending on the type of the electrode foil.

The driving signal generator 330 may generate a driving signal Idr adjusted according to the comparison result of the comparator 310 based on the comparison signal Scom. For example, when the comparison signal Scom is logic ‘1,’ the current temperature of the non-coated portion 22 of foil may be higher than the target temperature Vref, the driving signal generator 330 may decrease the size or intensity of the driving signal Idr, and when the comparison signal Scom is logic ‘0,’ the current temperature of the non-coated portion 22 of foil is lower than the target temperature Vref, the driving signal generator 330 may decrease the size or intensity of the driving signal Idr.

FIG. 9 is a diagram illustrating a comparator according to an embodiment.

Referring to FIG. 9, the comparator 310 may include a first comparator 312 and a second comparator 314.

The first comparator 312 may output a first comparison signal Scom1 by comparing the temperature detection signal Vd with an upper limit Vref1 of the target temperature. For example, when the temperature detection signal Vd is an upper limit Vref1 or more of the target temperature, the first comparison signal Scom1 may be logic ‘1,’ and when the temperature detection signal Vd is less than the upper limit Vref1 of the target temperature, the first comparison signal Scom1 may be logic ‘0.’

The second comparator 314 may output a second comparison signal Scom2 by comparing the temperature detection signal with a lower limit Vref2 of the target temperature. For example, when the temperature detection signal Vd is the lower limit Vref2 or less of the target temperature, the second comparison signal Scom2 may be logic ‘1,’ and when the temperature detection signal Vd is greater than the lower limit Vref2 of the target temperature, the second comparison signal Scom2 may be logic ‘0.’

For example, when the temperature detection signal Vd is the upper limit Vref1 or more of the target temperature, the first comparison signal Scom1 may be in a logic ‘1’ state, and the second comparison signal Scom2 may be in a logic ‘0’ state. For example, when the temperature detection signal Vd is the lower limit Vref2 or less of the target temperature, the first comparison signal Scom1 may be in a logic ‘0’ state, and the second comparison signal Scom2 may be in a logic ‘1’ state. For example, when the temperature detection signal Vd is less than the upper limit Vref1 of the target temperature and greater than the lower limit Vref2 of the target temperature, both the first comparison signal Scom1 and the second comparison signal Scom2 may be in a logic ‘0’ state.

In embodiments, logic ‘0’ may be a low level, logic ‘1’ may be a high level, and the logic ‘0’ and logic ‘1’ are merely examples, and may be for description and understanding, and may be at opposite levels, and are not limited to the examples.

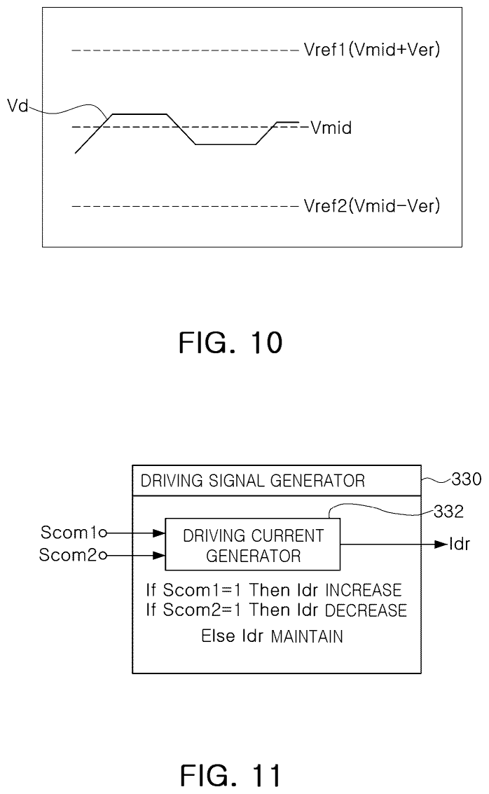

FIG. 10 is a diagram illustrating an upper limit of target temperature and a lower limit of target temperature according to an embodiment.

Referring to FIG. 10, the upper limit Vref1 of the target temperature may be determined to be higher than the intermediate value Vmid of the target temperature by a predetermined error tolerance value Ver. Accordingly, the upper limit Vref1 of the target temperature may be a value obtained by adding the error tolerance value Ver to the intermediate value Vmid of the target temperature (Vref1=Vmid+Ver).

The lower limit Vref2 of the target temperature may be determined to be lower than the intermediate value of the target temperature by the predetermined error tolerance value Ver. Accordingly, the lower limit Vref2 of the target temperature may be a value obtained by subtracting the error tolerance value Ver from the intermediate value Vmid of the target temperature (Vref2=Vmid−Ver).

FIG. 11 is a diagram illustrating a driving signal generator according to an embodiment.

Referring to FIG. 11, the driving signal generator 330 may include a driving current generator 332.

The driving current generator 332 may adjust the current value of the driving signal according to the first comparison signal Scom1 and the second comparison signal Scom2.

For example, when the first comparison signal Scom1 is in a logic ‘1’ state, the driving current generator 332 may increase the current value of the driving signal Idr, when the second comparison signal Scom2 is in a logic ‘1’ state, the driving current generator 332 may decrease the current value of the driving signal Idr, and when both the first comparison signal Scom1 and the second comparison signal Scom2 are in a logic ‘0’ state, the current value of the driving signal may be maintained.

In embodiments, the driving current generator 332 included in the controller 300 may be implemented as hardware or software in at least one integrated circuit (IC) embedded in the apparatus for heating a non-coated portion of foil 50, and may not be limited to a particular implementation method.

According to the aforementioned embodiments, in order to address the issue of fracture of the electrode sheet occurring in the electrode rolling process, by controlling the heating temperature for the non-coated portion differently depending on the type of electrode foil, the non-coated portion may swiftly ensure the appropriate tensile strength depending on the type of electrode foil, and accordingly, the effect of preventing fracture of the electrode sheet during electrode rolling may be provided.

Only specific examples of implementations of predetermined embodiments are described. Variations, improvements and enhancements of the disclosed embodiments and other embodiments may be made with respect to the disclosure of this patent document.

What is claimed is:

1. An apparatus for heating a non-coated portion of foil, the apparatus comprising:
a temperature detection unit spaced apart from one side of a non-coated portion of foil of an electrode sheet, configured to detect a temperature of the non-coated portion of foil in a non-contact manner and configured to output a temperature detection signal;
a controller configured to control heating of the non-coated portion of foil based on a temperature detection signal from the temperature detection unit; and
a heating means spaced apart from the other side of the non-coated portion of foil of the electrode sheet, and configured to heat the non-coated portion of foil under control of the controller.

2. The apparatus of claim 1, wherein the temperature detection unit includes an infrared temperature sensor spaced apart from the one side of the non-coated portion of foil to detect a temperature of the non-coated portion of foil.

3. The apparatus of claim 2, wherein the heating means includes an electromagnetic induction heating coil spaced apart from the other side of the non-coated portion of foil so as to heat the non-coated portion of foil under control of the controller.

4. The apparatus of claim 2, wherein the heating means includes:
a first support spaced apart from the other side of the non-coated portion of foil so as to be spaced apart from a lower surface of the non-coated portion of foil;
a heating plate disposed on an upper surface of the first support; and
an electromagnetic induction heating coil disposed on the heating plate and spaced apart from the other side of the non-coated portion of foil so as to heat the non-coated portion of foil under control of the controller.

5. The apparatus of claim 1, wherein the temperature detection unit includes:
an infrared temperature sensor spaced apart from the one side of the non-coated portion of foil to detect a temperature of the non-coated portion of foil; and
a second support configured to support and hold the infrared temperature sensor so as to be spaced apart from one side of the non-coated portion of foil.

6. The apparatus of claim 1, wherein the controller further includes:
a comparator configured to compare the temperature detection signal with a predetermined target temperature; and
a driving signal generator configured to generate a driving signal controlled according to a comparison result of the comparator.

7. The apparatus of claim 6, wherein the comparator includes:
a first comparator configured to output a first comparison signal by comparing the temperature detection signal with an upper limit of the target temperature; and
a second comparator configured to output a second comparison signal by comparing the temperature detection signal with a lower limit of the target temperature.

8. The apparatus of claim 7,
wherein an upper limit of the target temperature is determined to be higher than an intermediate value of the target temperature by a predetermined error tolerance value, and
wherein a lower limit of the target temperature is determined to be lower than an intermediate value of the target temperature by a predetermined error tolerance value.

9. The apparatus of claim 7, wherein the driving signal generator includes a driving current generator configured to control a current value of the driving signal according to the first comparison signal and the second comparison signal.
